(19) United States
(12) Patent Application Publication
(10) Pub. No.: US 2004/0092643 A1
(43) Pub. Date: May 13, 2004

(54) Silicone rubber formulations and the use thereof

(76) Inventors: Christoph Tiburtius, Koln (DE); Eckhard Wendt, Kongen (DE); Beate Ganter, Monheim (DE)

Correspondence Address: Norris McLaughlin & Marcus, 30th Floor, 220 East 42nd Street, New York, NY, 10017, US

(21) Appl. No.: 10/381,454

(22) PCT Filed: Sep. 25, 2001
(86) PCT No.: PCT/EP01/11092

(30) Foreign Application Priority Data
Sep. 25, 2000 (DE) 100 47 276.1

(51) Int. Cl. C08K 3/34

(52) U.S. Cl. 524/492

(57) ABSTRACT

Insulating material comprising silicone rubber formulations with low relative conductivity.

The present invention relates to silicone rubber formulations that have a low relative dielectric constant, and uses for said formulations, for example as insulating material.

In principle, high-voltage insulators may be made of any insulating inorganic or organic materials, provided that, in addition to the property of electric insulating capability, no other properties such as weather, corona, or UV-resistance are required.

In many cases, porcelain has proven particularly effective, especially for open-air high-voltage insulators.

Nevertheless, ever since 1977 porcelain has been successfully substituted with selected insulating thermoplastic materials from the group consisting of epoxides and urethanes, such as is described in DE 2 746 870, or with elastomers from the group consisting of ethylene vinyl acetate, acrylate copolymers, EPDM, or silicones, such as are described in U.S. Pat. No. 3,532,664 and U.S. Pat. No. 3,922,442. These materials have also proven effective in other areas in the production of insulators for energy transfer.

Silicone elastomers, in particular, have received increased attention due to their insulating properties, their regenerative behavior, their hydrophobicity following corona effect, in other words following high-voltage spark-overs and arc formation on the surface, and their resistance to atmospheric conditions, as is known from U.S. Pat. No. 3,965,065 and IEEE Transactions on Dielectrics and Electrical Insulation Vol. 6 No. 3, 1999. In a multitude of patents and publications, means are disclosed for fulfilling specific requirements to ever increasing degrees.

Most publications focus on maintaining the surface undamaged for as long as possible, under corona effect. The object is thus focused primarily on the simulation of the effects of weather and climate, as, e.g., with the spray tests presented in EP 470 745. The disadvantage here is that these tests are protracted.

A more rapid evaluation of corona resistance is conducted in the laboratory using methods that can be implemented over a relatively short period of time, such as e.g. arc resistance in accordance with DIN 57441, tracking resistance based upon current flow or resistance time under electrolyte effects measured in accordance with DIN 57303 VDE 0303 T. 10 IEC 587, and dielectric strength measured in accordance with VDE 0441. The test results, however, do not provide sufficient differentiation, so that a series of improvements were proposed in the evaluation. One possibility is the additional measurement of loss of mass, which goes beyond the standard, in an evaluation according to IEC 587.

In this, basically two essential principles of the silicone elastomers used have been found to be advantageous: These are the formulations of the non-flammable silicone rubbers that use aluminum trihydrate or a combination of this with borates, as are described in U.S. Pat. No. 3,965,065 or EP-A-0 928 008, and formulations with metal oxides from the group consisting of Ti-, Ce-, Fe-, Zr-oxides, other lanthanoid oxides, or spinels of Fe, Co, Ti in accordance with U.S. Pat. No. 4,399,064, U.S. Pat. No. 4,355,129, or U.S. Pat. No. 4,320,044. The addition of organic antioxidants is also known in the art. Furthermore, it is possible, when aluminum trihydrate or surface-rich TiO₂ is used, to improve its power capability via subsequent treatment. Improvements may also be achieved with selected surface areas or grain sizes or chemical purity levels. As a further technical solution it has been suggested that flame resistance or corona resistance be effected using additional quantities of Pt in the ppm range, as described in U.S. Pat. No. 4,288,360 or EP-A-0 218 461. The latter two patents describe cured rubbers catalyzed with peroxides. EP-0 218 461 teaches how rubbers having increased corona resistance can be generated using fine TiO₂ and platinum compounds, without using aluminum trihydrate. However, this produces elastomers that are cured using peroxides. No teaching as to how a corona-resistant elastomer can be generated without TiO₂ and without peroxide by selecting another suitable curing agent is provided there. The metal oxides or the aluminum oxide hydrates are used in quantities of 2-60%. This results in problems, since the large quantities of oxides used and the simultaneously desired, different coloration make the use of additional large quantities of other pigments necessary. This results in a loss of the usual advantages of the silicone insulators, such as adequate mechanical stability, low relative dielectric constant (DK)=high alternating current resistance, low electrical loss factor, low density, and good pigmenting.

Up to now, known systems have been cured primarily using peroxides or via hydrosilylation reactions.

The curing of highly loaded rubbers using a platinum-catalyzed hydrosilylation for applications in extremely heat and flame-resistant insulations has been described, e.g., in U.S. Pat. No. 4,269,753 and DE 197 40 631. From the U.S. Pat. No. 5,668,205, U.S. Pat. No. 5,880,199 additional examples of rubber are known, that are cured using SiH siloxanes. In these cases, more new additives have been incorporated into systems with aluminum trihydrate.

U.S. Pat. No. 5,994,461 discloses that the substitution of the linear vinyl siloxane polymer by a branched vinyl siloxane polymer, e.g. a resin, results in improved tracking, wherein the solid resins must first be dissolved in a solvent, in order to be able to react after being distributed among the other constituents of the mixture. EP-A-0 359 252 and EP-A-0 928 008 are specifically focused on increasing arc resistance and tracking.

The object of the present invention was to provide curable silicone rubber formulations that have a low relative dielectric constant, a low electrical loss factor, and high corona resistance, i.e. sufficiently low tracking and high arc resistance, which would not exhibit the disadvantages of the current state of the art.

Surprisingly, it was found that the disadvantages, such as low corona and high-voltage resistance for the aluminum oxide- and aluminum hydrate-free silicone rubber mixtures can be overcome with the silicone rubber formulations specified in the invention. The silicone rubber formulations specified in the invention exhibit a high level of resistance against corona effects, if they are cured using a hydrosilylation catalyst based upon a metal from the platinum group, using selected polyhydrogen siloxanes.

These are curable silicone rubber formulations that have the lowest possible relative dielectric constant (DZ). The DZ that contributes to determining the alternating current resistance should have a value of less than 3.3, preferably less than 3.2, furthermore the mixtures should have a low electrical loss factor of less than 0.015, preferably less than 0.010, and a low density of less than 1.3 g/cm³, and should contain few pigments, but still exhibit the performance capability of insulating mixtures currently known. In this, a rating of high-voltage resistance class and the loss of mass in the measurement of high-voltage tracking measured in accordance with IEC 587 are employed as an evaluating scale.

The present invention provides curable silicone rubber formulations, consisting of:

A) at least one polysiloxane of the formula (I)

R′SiR″₂O(SiR″₂O)ₓSiR″₂R′,

wherein the substituents R′ and R can be the same or different, and are each alkyl groups having 1-12 C atoms, aryl residues, vinyl residues, and fluoroalkyl residues having 1-12 C atoms, x has a value of 0 to 12,000, wherein the polysiloxane has at least two olefinic unsaturated multiple bonds, and may have branching units of the formula SiO_{4/2} and R′SiO_{3/2}, wherein R′ can have the meaning indicated above,

B) if desired, at least one filler material having a specific surface area of between 50 and 500 m²/g measured according to BET,

C) if desired, at least one filler material having a specific surface area of less than 50 m²/g measured according to BET,

D) if desired, at least one additional auxiliary agent,

E) if desired, at least one saturated hydrophobization agent from the group consisting of disilazanes, siloxane diols, alkoxysilanes, silylamines, silanols, acetoxysiloxanes, acetoxysilanes, chlorosilanes, chlorosiloxanes, and alkoxysiloxanes,

F) if desired, at least one unsaturated hydrophobization agent from the group consisting of multiple vinyl-substituted methyldisilazanes, and methylsilanols and alkoxysilanes, each with unsaturated residues from the group consisting of alkenyl, alkenylaryl, acryl and methacryl,

G) if desired, at least one trimethylsilyl end-blocked polysiloxane,

H) if desired at least one inhibitor for the hydrosilylation reaction,

I) at least one polyhydrogen siloxane that contains at least two hydrogen atoms that are bonded directly to different silicone atoms, in accordance with the formula II

X₂DₘD^{H}ₙ (II)

wherein

a) X=M, m: n>1, n≧2 and m+n>4,

b) X=M^{H}, M≧1,n≧0 and m+n≧1, or

c) X=M and M^{H}, m≧1 and n>0, and

J) at least one catalyst containing an element from the platinum group,

wherein the presence of more than 3 parts by weight metal oxides, such as oxides and/or carbonates, and additional salts and complex compounds of Fe, Al, Zn, Ti, Zr, Ce or other lanthanoids based upon 100 parts by weight of the component A) is excluded.

The silicone rubber formulations specified in the invention have a low relative dielectric constant, a low electrical loss factor, and an increased corona resistance.

In one preferred embodiment, the present invention provides silicone rubber formulations consisting of:

100 parts by weight of the component A),

0 to 75, preferably >0 to 75, parts by weight of the component B),

0 to 300 parts by weight of the component C),

0 to 10 parts by weight of the component D),

0 to 25, preferably >0 to 25, parts by weight of the component E),

0 to 2, preferably >0 to 2, parts by weight of the component F), −0 to 15 parts by weight of the component G),

0 to 1, preferably >0 to 1, parts by weight of the component H),

0.2 to 30, preferably 0.2 to 20, parts by weight of the component I), and

based upon the total quantity of components A) to I), 10 to 100 ppm of the component J), based upon the metal of the platinum group in the component J).

In a further preferred embodiment, the invention provides silicone rubber formulations, wherein

he polysiloxane A) is at least one polysiloxane of the formula (I):

R′SiR″₂O(SiR″₂O)ₓSiR″₂R′,

wherein the substituents R′ and R may be the same or different, and each are alkyl groups having 1-8 C atoms, aryl residues, vinyl residues, and fluoroalkyl residues having 3-8 C atoms, x has a value of 0 to 12,000, wherein the polysiloxane has at least two olefinic unsaturated multiple bonds,

the filler material B) has a specific surface area of between 50 and 400 m²/g measured according to BET, and

the catalyst is a catalyst from the platinum group J), which catalyzes the hydrosilylation reaction and is chosen from metals from the platinum group, such as Pt, Rh, Ni, Ru, and compounds of metals from the platinum group, as well as salts or complex compounds thereof.

In a further preferred embodiment, the invention provides silicone rubber formulations, wherein

the filler material B) is selected from silicic acids having a surface area of between 50 and 400 m²/g measured according to BET,

the unsaturated hydrophobization agent F) is selected from the group consisting of 1,3-divinyl tetramethyldisilazane and trialkoxysilanes, with unsaturated alkenyl, alkenylaryl, acryl, methacryl groups,

the trimethylsilyl end-blocked polysiloxane G) is selected from polysiloxanes containing dimethylsiloxy, diphenylsiloxy or phenylmethylsiloxy groups, provided it contains no functional groups that participate in the hydrosilylation reaction,

the polyhydrogen siloxane I) is a polyhydrogen siloxane having at least two hydrogen atoms that are directly bonded to different silicone atoms, of the formula II

X₂DₘD^{H}ₙ

wherein

a) X=M, m:n>1, n≧2 and m+n>4,

b) X=M^{H}, m≧1, n≧0 and m+n≧1, or

c) X=M and M^{H}, m≧1 and n>0,

and the D units may be replaced by D^{Vi}, D^{Phe2}, D^{PheMe}, T, T^{Phe}, Q, bis(dialkylsilyl)(C₁-C₈)-alkanediyl, such as bis-dialkylsilylmethylene or bis-dialkylsilylethylene or bis-dialkylsilylarylene, the DH units may be replaced with T^{H}, and the M units may be replaced by M^{Vi}, M^{Phe}, with an SiH content of less than 10 mmol/g, preferably less than 9 mmol/g, and wherein the MeSiHO units are statistically separated at least by one of the units D, D^{Phe2}, D^{PheMe}, bis-dialkylsilylmethylene, bis-dialkylsilylethylene, or bis-dialkylsilylarylene, and—the catalyst J) which contains an element from the platinum group, is selected from platinum and platinum compounds that may be deposited on a carrier, and other compounds of elements from the platinum group.

Further, in the silicone rubber formulations specified in the invention, preferably in the component I) in the polymer chain statistically no SiH units are adjacent, but are instead separated by other siloxy units, so that each MeSiHO-(D^{H})- or T^{H} unit is statistically separated by at least one of the units D^{Vi}, D^{Phe2}, D^{PheMe}, T, T^{Phe}, ′Q, bis(dialkylsilyl)(C₁-C₈)-alkanediyl, such as bis-dialkylsilylmethylene or bis-dialkylsilylethylene, or bis-dialkylsilylarylene from the next MeSiHO unit.

Further, in the silicone rubber formulations specified in the invention, the molar ratio of the sum of the SiH groups in the component I) to the sum of the Si vinyl groups in the components A) and F) is preferably 0.8 to 10.

Further, in the silicone rubber formulations specified in the invention, 20-100 ppm Pt, based upon the quantity of the components A) to I), in the form of Pt salts, Pt complex compounds with nitrogen, phosphorous and/or alkene compounds, or Pt metal on carriers are used as the catalyst J).

Further, in the silicone rubber formulations specified in the invention, the saturated hydrophobization agent E) is selected from the group consisting of disilazanes, silylamines, and/or silanols.

In the scope of the present invention, the component A) preferably has the meaning of linear or branched polysiloxanes of the general formula (I)

R∝SiR″₂O(SiR″₂O)ₓSiR″₂R′) (I)

wherein the substituents R′ and R may be the same or different, and are each alkyl residues containing 1-12 C atoms, aryl residues, vinyl residues, and fluoroalkyl residues having 1-12 C atoms, x has a value of 0 to 12,000, wherein the polysiloxanes contain at least two olefinic unsaturated multiple bonds, and may contain branching units of the formula SiO_{4/2} and R′SiO_{3/2}, wherein R′ can have the meaning indicated above.

The residues R′ can be the same as or different from a polysiloxane molecule of the formula (I). The residues R″ can be the same as or different from a polysiloxane molecule of the formula (I). In the present invention, the residues R″ are preferably alkyl groups having 1-12 C atoms. In the scope of the present invention, alkyl residues having 1-12 C atoms expediently are aliphatic carbon-hydrogen compounds containing 1 to 12 carbon atoms, which can be straight-chain or branched. Examples are methyl, ethyl, propyl, n-butyl, pentyl, hexyl, heptyl, nonyl, decyl, iso-propyl, neopentyl, and 1,2,3-trimethylhexyl. Preferably, R′ and R″ are selected from methyl and vinyl.

In the scope of the present invention, the phrase “fluoroalkyl residues having 1-12 C atoms are” means aliphatic carbon-hydrogen residues having 1 to 12 carbon atoms that can be straight-chain or branched, and are substituted by at least one fluorine atom. Examples are perfluoroalkylethylene, 1,1,1-trifluoropropyl, and 1,1,1-trifluorobutyl. Trifluoropropyl is preferably R″.

In the scope of the present invention, the term “aryl” means unsubstituted phenyl, or phenyl that is single- or polysubstituted with F, C₁, CF₃, C₁-C₆-alkyl, C₁-C₆ alkoxy, C₃-C₇ cycloalkyl, C₂-C₆ alkenyl or phenyl-substituted phenyl. The term may also refer to naphthyl. Phenyl is preferably R″.

The viscosity of the component A) preferably amounts to between 10⁻³ and 50,000 Pa.s at 25° C. in the shear rate variations of D=1 sec−1, more preferably between 1 and 30,000 Pa·s and most preferably between 10 and 25,000 Pa·s.

In the nomenclature that is familiar to members of the profession (W. Noll: Chemie und Technologie der Silikone [Chemistry and Technology of Silicones], VCH, Weinheim, 1968):

Q: SiO_{4/2}

M: (CH₃)₃SiO_{1/2}

D: (CH₃)₂SiO_{2/2}

T: (CH₃)SiO_{3/2}

M^{Vi}: (CH₂═CH)(CH₃)2SiO_{1/2}

D^{Vi}: (CH₂═CH)(CH₃)SiO_{2/2},

the following examples for the general structure of the component A) are indicated:

M₂D₁₀₀₋₁₀₀₀D₃₋₃₀^{Vi}

M₂^{Vi}D₁₀₀₋₈₀₀₀

M₂D₁₀₋₆₀₀₀

M₂^{Vi}D₄₀₀₀₀₋₁₀₀₀₀₀D₇₋₂₀₀₀^{Vi}

M₂^{Vi}D₄₀₀₀₋₁₀₀₀₀

QM^{Vi}₁₋₄S_{0, 1-20}.

In this, the indices refer to the ranges of the average degrees of polymerization.

The molar share of unsaturated residues can be chosen as desired. The molar share of unsaturated groups expediently lies between 0 and 5 mmol/g, preferably 0.02 to 0.05 mmol/g.

In the scope of the present invention, the component B) has the meaning of a filler material having a specific surface area of between 50 and 500 m²/g measured according to BET. This expediently involves reinforced filler material. Reinforcement in this case means that the properties of mechanical strength are improved, especially tensile strength, tear resistance, etc. The reinforcing filler material is expediently added such that the electrical properties of the cured mixtures specified in the invention are positively affected, or not adversely affected. This is achieved, e.g., by adding precipitated or pyrogenic silicic acids having a BET surface area of 50 to 500 m²/g (The BET surface is determined in accordance with S. Brunauer, P. H. Emmett, E. Teller, J. Am. Soc. 60.309 (1938)). The filler materials may be hydrophobic or hydrophilic filler materials. The filler materials B) can be surface-modified, i.e. hydrophobized, e.g. with silicone organic compounds. The modification can take place before or even during the compounding of the silicone rubber formulations specified in the invention. Preferably, the hydrophobization with the components E) and/or F) takes place with the addition of water, if desired. Preferably, the hydrophobization with saturated or unsaturated disilazanes and methylsilanols, which can also be produced from the disilazanes, is implemented in accordance with the definition of the components E) or F).

Preferred ranges for the BET surface area of the filler material B) are 50 to 400, most preferably 150 to 300 m²/g. The quantity of the component B) expediently amounts to between 0 and 75 parts by weight per 100 parts by weight of the component A), preferably 20 to 50 parts by weight.

In the scope of the present invention, the component C) is at least one filler material having a specific surface area of less than 50, preferably less than 40, even more preferably less than 30 m²/g measured according to BET. Expediently these are so-called “non-reinforcing filler materials”, which do not improve mechanical properties, especially tensile strength, tear resistance, etc. Preferably these are diatomaceous earth, fine-grain quartz or crystabolite powders, other amorphous silicic acids, or silicates. The quantity of the component C) expediently amounts to between 0 and 300 parts by weight per 100 parts by weight of the component A), preferably 0 to 50 parts by weight.

In the scope of the present invention, the term “auxiliary agent” with reference to component D) expediently includes pigments, separating agents, extrusion agents, and hot-air stabilizers, i.e. stabilizers against hot-air aging. Expediently, the separating agents are chosen from the group of mould-release agents such as stearyl derivatives or waxes, metallic salts, or fatty acids. Extrusion agents are e.g. boric acid or PTFE pastes. Hot-air stabilizers are e.g. metal oxides, such as oxides and/or carbonates, as well as other salts and complex compounds of Fe, Al, Zn, Ti, Zr, Ce, or other lanthanoids and antioxidation agents. The quantity of component D) amounts expediently to between 0 and 10 parts by weight per 100 parts by weight of the component A), wherein the presence of more than 3 parts by weight, preferably more than 2 parts by weight, metal oxides, such as oxides and/or other salts and complex compounds of Fe, Al, Zn, Ti, Zr, Ce or other lanthanoids is excluded. Preferably, the silicone formulation specified in the invention contains no metal oxides, such as oxides and/or carbonates, and no additional salts and complex compounds of Fe, Al, Zn, Ti, Zr, Ce or other lanthanoids.

In the scope of the present invention, the component E) is at least one saturated hydrophobization agent from the group consisting of disilazanes, siloxane diols, alkoxysilanes, silylamines, silanols, acetoxy siloxanes, chlorosilanes, chlorosiloxanes, and alkoxysiloxanes. The component E) serves to hydrophobize the filler material C) and preferably B). The hydrophobization can take place separately prior to the compounding, or in situ during the compounding. The quantity of the component E) expediently amounts to 0 to 25 parts by weight, based upon 100 parts by weight of B).

In the scope of the present invention, the component F) is at least one unsaturated hydrophobization agent from the group consisting of poly vinyl-substituted methyldisilazanes, and methylsilanols and alkoxysilanes, each with unsaturated residues from the group consisting of alkenyl, alkenylaryl, acryl, and methacryl. The component F) also serves as a hydrophobization agent for the filler materials B) and C). The quantity of the component F) expediently amounts to 0 to 2 parts by weight, based upon 100 parts by weight of A).

The total quantity of the components E) and F), based upon the total quantity of the components B) and C), preferably B), preferably amounts to 5-25% by weight.

In the scope of the present invention, the term “trimethylsilyl end-blocked polysiloxanes” in reference to the component G) is expediently understood to mean low-molecular, non-functional in terms of the hydrosilylation reaction, non-curing trimethylsilyl end-blocked polysiloxanes containing dimethyl, diphenyl, or phenylmethylsiloxy groups having polymerization degrees of 4 to 1000, which following curing to a shaped article, reliably hydrophobize the surface of the insulators, as is described e.g. in EP-A-0 57 098. The quantity of the component G) expediently amounts to 0 to 15, preferably 1 to 3 parts by weight, based upon 100 parts by weight of A).

In the scope of the present invention, the term “inhibitor for the hydrolyzing reaction” in reference to the component H) encompasses all known-in-the-art inhibitors for the hydrosilylation reaction with metals of the Pt group, such as maleic acid and its derivatives, amines, azoles, alkylisocyanurates, phosphines, phosphites, and acetylenic unsaturated alcohols, wherein the OH group is bonded to a carbon atom that is adjacent to the C-C triple bond, as is described in greater detail, e.g., in U.S. Pat. No. 3,445,420. Preferably the component G) is 2-methyl-3-butin-2-ol or I-ethinylcyclohexanol or (±)3-phenyl-1-butin-3-ol. The component H) is preferably used in a quantity of 0 to 1 part by weight based upon 100 parts by weight A) through I). Preferably, the component H) is contained in a quantity of 0.0001% to 2% by weight, based upon the total weight of the mixture, especially preferably 0.01% by weight to 2% by weight, and most preferably 0.05% by weight to 0.5% by weight.

The component J) is a catalyst, containing at least one element from the platinum group. Preferably, the component J) is a catalyst that catalyzes the hydrosilylation reaction, and is selected from metals from the platinum group, such as Pt, Rh, Ni, Ru, and compounds of metals from the platinum group, as well as salts or complex compounds thereof. More preferably, the component J) is a catalyst containing one element from the platinum group, selected from platinum and platinum compounds, which may be deposited on a carrier, and other compounds of elements from the platinum group. Platinum and platinum compounds are most preferred. Thus, Pt salts, Pt complex compounds with nitrogen, phosphorous and/or alkene compounds, or Pt metal are preferably deposited on carriers. Preferred are all Pt (0)- and Pt-(I) compounds, preferred are Pt-olefinic complexes and Pt vinyl siloxane complexes. Especially preferred are Pt vinyl siloxane complexes, Pt vinyldi- and tetrasiloxane complexes, which preferably have at least 2 or 4 olefinic unsaturated double bonds in the siloxane (see e.g. U.S. Pat. No. 3,715,334). In this connection, the term siloxane also includes polysiloxanes or even polyvinyl siloxanes.

Furthermore, component J) can also be a conversion product from reactive platinum compounds with the inhibitors H).

The quantity of the component J) in the formulation specified in the invention, based upon the total quantity of the components A) through I), preferably amounts to 10 to 100 ppm, preferably 15 to 80 ppm, and most preferably 20 to 50 ppm, based upon the metal of the platinum group in the component J). Preferably, the silicone rubber formulations contain 20-100 ppm Pt, based upon the quantity of the components A) through J), in the form of Pt salts, Pt complex compounds with nitrogen, phosphorous, and/or alkene compounds, or Pt metal on carriers.

In the scope of the present invention, the component I) has the meaning of at least one polyhydrogen siloxane, that has at least two hydrogen atoms bonded directly to different silicone atoms, in accordance with the formula (II)

X₂D^{m}D^{H}ₙ (II)

wherein

a) X=M, m:n>1, n≧2 and m+n>4,

b) X=M^{H}, m≧1, n≧0, and m+n≧1, or

c) X=M and M^{H}, m≧1 and n>0,

and the D units may be replaced with D^{Vi}, D^{Phe2}, D^{PheMe}, T, T^{Phe}, Q, bis(dialkylsilyl)(C₁-C₈)alkanediyl, such as bis-dialkylsilylmethylene or bis-dialkylsilylethylene or bis-dialkylsilylarylene, the DH units may be replaced by TH, and the M units can be replaced by M^{Vi}, M^{Phe}.

In the nomenclature familiar to professionals in the field:

M=(CH₃)₃SiO_{1/2}

M^{H}=H(CH₃)₂SiO_{1/2}

D=(CH₃)₂SiO_{2/2}

D^{H}=H(CH₃)SiO_{2/2}

D^{Vi}=(CH₂═CH)(CH₃)SiO_{2/2}

D^{Phe2}=(Phe)₂SiO_{2/2}

D^{PheMe}=(Phe)(CH₃)SiO_{2/2}

T=(CH₃)SiO_{3/2}

T^{Phe}=(Phe)SiO_{3/2}

Q=SiO_{4/2}

T^{H}=(H)SiO_{3/2}

M^{Vi}:(CH₂═CH)(CH₃)₂SiO_{1/2}

M^{Phe}=(Phe)₃SiO_{1/2}, (Phe)₂(CH3)SiO_{1/2}, (Phe)(CH₃)₂SiO_{1/2}

The following examples may be provided with the known preferred ranges for the indices m and n:

M₂^{H}D_{10-1,000}

M₂D₁₋₅₀₀D₁₋₁₀₀^{H}

M₂^{H}D₁₋₅₀₀D₁₋₂₀₀^{H}

M₂^{Vi}D₁₋₅₀₀^{H}

M₂D₁₋₅₀₀^{Vi}D₁₋₂₀₀^{H}

and

Q₁₋₁₀M^{H}₁₋₄D_{0, 1-200}

In this, the indices are the average degrees of polymerization, and the above-named ratios for the indices m and n apply.

In the component I) the molar share of hydrogen atoms bonded directly to a silicone atom preferably lies between 0.01 and 10 mmol/g, especially preferably between 0.5 and 9 mmol/g, and most preferably between 1 and 7 mmol/g.

The quantity of the component I) is preferably 0.2 to 30, preferably 0.2 to 20 parts by weight based upon 100 parts by weight of the component A).

In the silicone rubber mixture specified in the invention, the components A)+F), and I) should preferably be present in such a quantity ratio that the molar ratio of hydrogen bonded directly to a silicone atom (SiH) in the component I) to unsaturated residues in the components A) and F) lies between 0.1 and 20, preferably between 0.8 and 10, and most preferably between 1 and 5.

The silicone rubber formulations specified in the invention are consisting of the components A) through J), with the components B) through H) being optional. The silicone rubber formulation specified in the invention preferably contains, in addition to the necessary components A), I) and J), the components B), E) and F). If the component J) is not a conversion product with the component H), then H) should also be contained in the formulation. Further, a composition that contains the components A), I), J), B), E), F) and H) is preferred.

The invention further relates to a method for producing the silicone rubber formulations specified in the invention, which is characterized in that the components A) through I) are combined and mixed.

Preferably, the production of the silicone rubber formulations specified in the invention, in which the optional hydrophobization agents E) and F) and if necessary water are added to the component A), and the component D) (filler material) is incorporated at temperatures of 20 to 160° C. in a nitrogen atmosphere, thereby hydrophobization the filler material D) in a reaction with the components E) and F). Excess reaction products E) and F) as well as volatile reaction products (such as silanols, alcohols and water) are then removed (preferably by heating to 150° to 170° C., possibly in a vacuum). To the resulting, preferably cooled mixture the components H) and I), or J) in the case of a two-component formulation, are added in batches. If the components C), D), and G) are required, they are added in batches following removal of the volatile components E) and F). In the case of the single-component formulation, H), I) and J) are added in batches, with the inhibitor H) being added first.

Customary mixers are used.

The curable silicone rubber masses specified in the invention can be 1-, 2- or even multicomponent systems. Multicomponent systems are e.g. those that contain H), I) and J) separately.

The invention further relates to moulded components that are produced by curing the silicone formulations specified in the invention, preferably at temperatures of 20 to 250° C.

A further object of the invention is the use of the silicone rubber formulations or the moulded components produced using said formulations in accordance with one of the claims 1 through 10 to produce insulating materials, especially to produce corona and weather resistant insulators, especially for the mounting, suspension, and support of lines for electrical power transference, such as high-voltage insulators, especially as outdoor insulators, rod-type suspension insulators, pin-type insulators, traction or hollow insulators, cable fittings, cable couplings, cable junction boxes, or cable terminal boxes.

It was surprisingly found that an increased platinum content and the polyhydrogen siloxane selected in accordance with the invention produce a positive effect on the high-voltage tracking resistances (HK) for the elastomers. To this end, the elastomers are evaluated in accordance with the IEC 587 test. The results are found in the examples in Tables 2 and 3.

### EXAMPLES

The following examples serve to further elucidate the invention, without serving to limit its scope.

A) Production of the Silicone Rubber Basic Mixture

A1 Transparent Pastes that Serve as the Prestages for the Examples 1-10

In a kneader 500 g of polymer P1 (SiVi=0.03 mmol/g 65 Pa. s) and 350 g polymer P2 (SiVi=0.05 mmol/g 10 Pa.s) each as the component A) were mixed with 90 g hexamethyldisilazane as the component E), 0.45 g 1,3-divinyltetramethyldisilazane as the component F), and 30 g water, under N2 protective gas. 360 g pyrogenic silicic acid Aerosil 300 having a BET surface area of 300 m²/g were then added as the component B) in 5 portions, and all constituents were mixed evenly to form a homogeneous paste; this was heated for 20 minutes under reflux to 90 to 100° C.; after being further heated to 150° to 160° C. the evaporable constituents were removed under N₂, the mixture was cooled to 100° C., and another 150 g polymer P2 were added as component A). With the help of cooling water in the outer wall of the kneader, this paste was cooled to 40° to 50° C.

A2) Pigmented Pastes that Serve as Prestages for the Examples 11-12 (Comparison Tests)

After cooling, an additional 7 g pyrogenic, surface-rich TiO₂ (P25 Degussa tube) per 100 g of mixture was then added to the mixture of A1 in the manner described above.

A3) Transparent Basic Mixtures of (Solid) Rubbers with Siloxane Diols as the Hydrophobization Agents

In a double-shaft kneader, 500 g of a vinyl end-blocked polysiloxane as the component A) with a polymerization degree of Pn 4000 and a vinyl content of 0.006 mmol/g (P3), 500 g vinyl-terminated polysiloxane as component A) with Pn 4000, and an additional MeViSiO units and a vinyl content of 0.026 mmol/g (P4), 450 g pyrogenic silicic acid (BET surface area 200 m²/g) as component B), 76 g polydimethylsiloxane diol Pn 10 as component E) with 4 g vinyltriethoxysilane as component F), as well as 12 g hexamethyldisilazane as component E), were mixed at 90° to 120° C. to form a homogeneous rubber over the period of one hour. This was then heated in the kneader to 150° to 160° C., and the low-boiling constituents, such as alcohols, water, etc., were evaporated under N₂.

Production of the Reactive Components: Pt Components:

B1) Pt components for the Examples 1 through 12

The cooled basic mixture of A1 was divided into 100 g portions. The cooled basic mixture of A2 was divided into 107 g portions.

To 100 g of the basic mixture of A1, 0.0745 ml (Examples 6-10, 12)/0, 3725 ml (Examples 1-5, 11) (D 0.967 g/cm³) 1-ethinylcyclohexanol as component H), and 1.07 g (Examples 1-5, 11) or 5.35 g (Examples 6-10, 12) of a complex compound of a Pt-(0)-vinyl siloxane complex containing 0.15% Pt, dissolved in polymer P1 (corresponding to component A) were dosed from a pipette; the constituents were mixed for 15 minutes in a plastic container using a dough hook on a kitchen mixer, forming a homogeneous paste.

B2) Production of the Reactive Component with Pt Catalyst for the Examples 13-16

The catalyst batch was consisting of platinum phosphite complex Pt [PR₃]₄ in which R was a phenyl residue], in which the catalyst was dispersed via a solvent in a vinyl end-blocked polydimethylsiloxane (corresponding to component A)) with a viscosity of 10 Pas (0.05 mmol/g Si-vinyl), so that the platinum content of the batch following evaporation of the solvent amounted to 0.1% platinum in the batch.

C1) SiH Curing Component for Basic Mixture A1 and A2

To 100 g (A1; Examples 1-10) and 107 g (A2; Examples 11-12) of the basic mixture of A1/A2, 6 to 28.4 parts by weight per 100 parts by weight A1 or 107 parts by weight A2 of the different SiH siloxanes (CL 1CL 5, as defined in Table 1) were dosed from a pipette into a plastic container in accordance with the ratios given in Table 2 as component T); these were then mixed for 15 minutes using a dough hook on a kitchen mixer, forming a homogeneous paste.

The dosing of the SiH siloxanes is based upon the vinyl content and the associated constant stoichiometry. This requires higher quantities of curing agent added (component I) with a decreasing Si—H content.

C2) SiH Curing Agent Component for Basic Mixture A3) for the Examples 15 and 16

59% trimethylsilyl end-blocked polydimethylsiloxane having a polymerization degree of 4000 and a viscosity of 20 kPa.s at 25° C. and a shear rate variation D=1 sec−1, 30% trimethylsilyl end-blocked polymethylhydrogen dimethylsiloxane CL 2.11% hydrophilic pyrogenic silicic Aerosil 200 (BET surface area 200 m²/g).

C3) SiH Curing Agent Component for Basic Mixture A3) for the Examples 13 and 14

C3 is consisting of 59% trimethylsilyl end-blocked polydimethylsiloxane with a polymerization degree of 4000, 30% trimethylsilyl end-blocked polymethyl hydrogen dimethylsiloxane CL 3, 11% hydrophilic pyrogenic silicic acid Aerosil 200 (BET surface area 200 m²/g).

D) Production of the Cured, Elastomeric Test Plates

D1 Method for curing B1+C1 (Examples 1-12)

In a plastic container, for each 100/107 g of the components B1/B2+6.6 g of a vinyl siloxane (V200 in Table 2) with a viscosity of 150 mPa.s and 2.08 SiVi mmol/g as component A) were combined with 106-128/113-135 g of the component C1; the 3 components were mixed for 15 minutes using the dough hook of a kitchen mixer, forming a homogeneous paste.

This was then brushed into a mould plate in a quantity of ca. 120 to 130 g, the mould plate and cover plate were fed into a vulcanization press (333N/cm²), where they were pressed and heated to 150° C. for 10 minutes, after which a plate measuring 6×100 mm×180 mm was removed from the moulding cavity; this was then tempered for 4 h at 200° C. under fresh air in an air-circulating oven.

D2 Method for Curing B2+C2 or C3 (Examples 13-16)

The Examples 13-16 were produced in accordance with customary methods for solid silicone rubber formulations using a rolling mill. The sequence of additions is irrelevant.

E) Tests of the Elastomers Under High-Voltage Stress

In a device designed for testing high-voltage tracking in accordance with DIN 57 303/IEC 587 VDE 303 part 10, 5 to 10 test plates measuring 6×50×120 mm were evaluated with respect to the maximum allowable limiting current 60 mA, the hole depth, and the loss of mass at a predetermined high-voltage level. In the evaluation, i.a. the percentage of the plates having a hole depth of more than 6 mm was determined.

The loss of mass was determined after cleaning. In this it was understood that the erosion products that could be easily removed from the elastomer plate (ash, cinders) were first removed mechanically. The constituents that still remained were then rubbed off using a rough cloth.

Grading into voltage classes was implemented essentially in accordance with the current-limit criterion, i.e. not exceeding 60 mA for 2 sec. within the 6 h duration of the test.

TABLE 1
Composition of the SiH Curing Agent CL 1 through 5

| | SiH | | |
|---|---|---|---|
| | mmol/g | n | m |
| CL 1 | 2.3 | 20 | 100 |
| CL 2 | 4.3 | 10 | 20 |
| CL 3 | 7.3 | 20 | 18.7 |
| CL 4)* | 9.3 | 3.3 | 2.7 |
| CL 5 | 11 | 30 | 10 |

Formula III M₂ Dₘ D^{H}ₙ
Formula IV Qₘ M^{H}ₙ)* corresponds to CL 4

TABLE 2
Composition and Electrical Testing of the Mixtures with
Disilazane Hydrophobized Filler Material

| | SiVi/SiH | | | | | | | | | | | | |
|---|---|---|---|---|---|---|---|---|---|---|---|---|---|
| Examples | mmol/g | 1 | 2 | 3 | 4 | 5 | 6 | 7 | 8 | 9 | 10 | 11 | 12 |
| Comparison | | | | | | | | | | | | | |
| Basic mixture | 0.033 | 100 | 100 | 100 | 100 | 100 | 100 | 100 | 100 | 100 | 100 | 100 | 100 |
| V 200 (g) | 2.08 | 3.3 | 3.3 | 3.3 | 3.3 | 3.3 | 3.3 | 3.3 | 3.3 | 3.3 | 3.3 | 3.3 | 3.3 |
| Ti02P25 | — | — | — | — | — | — | — | — | — | — | — | 7 | 7 |
| CL 1 | 2.3 | 14.2 | | | | | 14.2 | | | | | | |
| CL 2 | 4.3 | | 7.6 | | | | | 7.6 | | | | | |
| CL 3 | 7.3 | | | 4.5 | | | | | 4.5 | | | | |
| CL 4 | 9.3 | | | | 3.5 | | | | | 3.5 | | | |
| CL 5 | 11 | | | | | 3.0 | | | | | 3.0 | 3.0 | 3.0 |
| Sum of parts | | 117 | 111 | 108 | 107 | 106 | 117 | 111 | 108 | 107 | 106 | 106 | 106 |
| Containing | | | | | | | | | | | | | |
| Pt | ppm | 8 | 8 | 8 | 8 | 8 | 40 | 40 | 40 | 40 | 40 | 8 | 40 |
| ECH | ppm | 360 | 360 | 360 | 360 | 360 | 1800 | 1800 | 1800 | 1800 | 1800 | 360 | 1800 |
| SiVi | | 10.2 | 10.2 | 10.2 | 10.2 | 10.2 | 10.2 | 10.2 | 10.2 | 10.2 | 10.2 | 10.2 | 10.2 |
| SiH | | 32.6 | 32.6 | 32.6 | 32.6 | 32.6 | 32.6 | 32.6 | 32.6 | 32.6 | 32.6 | 32.6 | 32.6 |
| SiH:SiVi | | 3.2 | 3.2 | 3.2 | 3.2 | 3.2 | 3.2 | 3.2 | 3.2 | 3.2 | 3.2 | 3.2 | 3.2 |
| Evaluation | | | | | | | | | | | | | |
| HK-4.5 kV² | Fulfilled | yes | yes | no | no | no | yes | yes | no | yes | yes | no | yes |
| Loss of mass³ | % | 0.4 | 2.0 | 2.2 | 3.3 | 5.1 | 0.4 | 0.4 | 1.4 | 0.4 | 2.8 | 4.45 | 0.39 |
| Number of 6 mm | Ratio | 0 | 3:10 | 2:10 | 3:10 | 3:5 | 0 | 0 | 2:10 | 0 | 4:10 | 3:5 | 0 |
| holes | % | 0 | 30 | 20 | 30 | 60 | 0 | 0 | 20 | 0 | 40 | 60 | 0 |
| Share of holes | | | | | | | | | | | | | |
| DZ (rel. DK) | — | | | | | | | | | | 3 | 3.3 | |
| tan delta | — | | | | | | | | | | 0.0009 | 0.0168 | |

DK = relative dielectric constant at 50 Hz 25 C and tan delta as electric loss factor in accordance with DIN 53483,
²measured in accordance with DIN 57303 IEC 587 60 mA 2 sec over 6 h
³measured before and after the test

Interpretation of the test results Examples 1 through 12. The test of the Si rubber cured using different SiH curing agents showed that in tests 1 or 6.7 and 12 the lowest losses of mass as well as the smallest number of plates having erosion depths of more than 6 mm occurred. At the same time, the high-voltage resistance class 4.5 kV was achieved. The best resistance levels were achieved using the curing agent CL 1 Tab 1, with both low and high Pt concentrations, however the structurally different curing agent CL 4 also enables a high level of resistance.

In Examples 1 through 6, the effect of an increased quantity of the Pt catalyst (40 rather than 8 ppm) on tracking was shown. The quantity of Pt increased in Example 7 over Example 2 caused the rubber containing the curing agent CL 3 to also be raised to the level of Example 6 with respect to loss of mass and number of holes. The effect of an increased quantity of platinum was also observed in Example 12.

Examples 11 and 12 corresponded with the state of the art as described in EP 218 641 with respect to the TiO₂ and Pt concentrations 7, to which, in contrast to the claims therein, the SiH siloxanes specified in the invention, rather than peroxide, were admixed for the purpose of curing. In contrast to the other examples, Examples 11 and 12 exhibited an increased dielectric constant as well as higher electrical loss factors, wherein the alternating current resistance is lower than that of the examples that are without the TiO₂.

TABLE 3
Composition and Electrical Testing of the Mixtures with Siloxane
Diol Hydrophobized Filler Material in the Examples 13 through 16.

| | mmmol/g | | | | |
|---|---|---|---|---|---|
| Basic Mixture | 0.025 | 95.6 | 94.8 | 92.9 | 94.9 |
| Pt Batch B2 | 0.05 | 2.6 | 2.6 | 2.5 | 1.3 |
| SiH Batch C2 | — | — | — | 4.6 | 3.8 |
| SiH Batch C3 | | 1.8 | 2.6 | | |
| Total Portions | | 100 | 100 | 100 | 100 |
| Incl. | | | | | |
| CL 2 | 4.3 | | | 1.4 | 1.1 |
| CL 3 | 7.3 | 0.5 | 0.8 | | |
| Pt | ppm | 26 | 26 | 25 | 13 |
| SiVi | | 2.5 | 2.5 | 2.4 | 2.4 |
| SiH | | 3.9 | 5.7 | 5.9 | 4.9 |
| SiH:SiVi | | 1.6 | 2.3 | 2.5 | 2.0 |
| Evaluation | | | | | |
| HK-3.5 kV² | Fulfilled | yes | yes | yes | yes |
| Loss of Mass | % | 1.3 | 1.1 | 0.7 | 1.3 |
| Number of 6 mm Holes | Ratio | 1:5 | 1:5 | 0 | 1:5 |
| Ratio | % | 20 | 20 | 0 | 20 |
| DZ (rel. DK) | | 3 | 3 | 3 | 3 |

Interpretation of the Results of Tests 13 through 16

The high-voltage tracking resistance (HK) of all examples in Table 3 did not differ measurably from one another and reached only the 3.5 kV class. Here, the hydrophobization of the filler material is different from that of the elastomers in Table 2. Resistance to high-voltage tracking, here the share of holes and the loss of weight, is also observed for the types of rubber for which the hydrophobization is different due to the selection of the components E) and F) for the filler material. The different SiH content, at the same time an expression for the sequence of the SiH units, influences mass loss and hole numbers.

Example 15 showed the highest resistance in terms of loss of mass and hole formation. In comparison with Example 16, this was achieved with a higher Pt content, and in comparison with Examples 13 and 14 it was achieved by using the SiH siloxane CL2 rather than CL 3. The SiH curing agent CL2 that was used had a lower SiH content than the Examples 13 and 14.

1) Silicone rubber formulations, consisting of
A) at least one polysiloxane of the formula (I)
R′SiR″₂O(SiR″₂O)ₓSiR″₂R′,
wherein the substituents R′ and R can be different, and are each alkyl residues having 1-12 C atoms, aryl residues, vinyl residues and fluoroalkyl residues having 1-12 C atoms, x has a value of 0 to 12,000, wherein the polysiloxane has at least two olefinic unsaturated multiple bonds, and may have branching units of the formula SiO_{4/2} and R′SiO_{3/2}, wherein R′ can have the meaning indicated above,
B) if desired at least one filler material having a specific surface area of between 50 and 500 m²/g measured according to BET
C) if desired at least one filler material having a specific surface area of less than 50 m²/g measured according to BET,
D) if desired at least one additional auxiliary agent,
E) if desired at least one saturated hydrophobization agent from the group consisting of disilazanes, siloxane diols, alkoxysilanes, silylamines, silanols, acetoxysiloxanes, acetoxysilanes, chlorosilanes, chlorosiloxanes, and alkoxysiloxanes,
F) if desired at least one unsaturated hydrophobization agent from the group consisting of multiple vinyl-substituted methyldisilazanes, and methylsilanols and alkoxysilanes, each with unsaturated residues from the group consisting of alkenyl, alkenylaryl, acryl and methacryl,
G) if desired at least one trimethylsilyl end-blocked polysiloxane,
H) if desired at least one inhibitor for the hydrosilylation reaction,
I) at least one polyhydrogen siloxane that has at least two hydrogen atoms that are directly bonded to different silicone atoms, in accordance with the formula II
X₂DₘD^{H}ₙ
wherein
a) X=M, m:n>1, n≧2 and m+n>4,
b) X=M^{H}, m≧1, n≧0 and m+n≧1, or
c) X=M and M^{H}, m≧1 and n>0, and
the D units may be replaced if desired by D^{Vi}, D^{Phe2}, D^{PheMe}, T, T^{Phe}, Q, bis(dialkylsilyl)(C₁-C₈)-alkanediyl, such as bis-dialkylsilylmethylene or bis-dialkylsilylethylene or bis-dialkylsilylarylene, the D^{H} units may be replaced if desired by TH,
and the M units may be replaced by M^{Vi}, M^{Phe}, and
J) at least one catalyst containing one element from the platinum group, wherein the presence of more than 3 parts by weight metal oxides, such as oxides and/or carbonates as well as additional salts and complex compounds of Fe, Al, Zn, Ti, Zr, Ce or other lanthanoids based upon 100 parts by weight of the Component A) is excluded.

2) Silicone rubber formulations pursuant to claim 1 consisting of:
100 parts by weight of the component A),
0 to 75 parts by weight of the component B),
0 to 300 parts by weight of the component C),
0 to 10 parts by weight of the component D),
0 to 25 parts by weight of the component E),
0 to 2 parts by weight of the component F),
0 to 15 parts by weight of the component G),
0 to 1 part by weight of the component H),
0.2 to 30 parts by weight of the component I), and based upon the total quantity of the components A) through I), 10 to 100 ppm of the component J), based upon the metal from the platinum group in the component J).

3) Silicone rubber formulations pursuant to claim 1 or 2, wherein
the polysiloxane A) is at least one polysiloxane of the formula (I):
R′SiR″₂O(SiR″₂O)gSiR″₂R′,
wherein the substituents R′ and R may be the same or different, and each are alkyl residues having 1-8 C atoms, aryl residues, vinyl residues, and fluoroalkyl residues having 3-8 C atoms, x has a value of 0 to 12,000, wherein this polysiloxane has at least two olefinic unsaturated multiple bonds, and may have branching units of the formula SiO_{4/2} and R′SiO_{3/2} if necessary, wherein R′ can have the meaning indicated above,
the filler material B) has a specific surface area of between 50 and 400 m²/g measured according to BET, and
the catalyst from the platinum group J) is a catalyst that catalyzes the hydrosilylation reaction, and is selected from metals of the platinum group, such as Pt, Rh, Ni, Ru, and compounds of metals from the platinum group, as well as salts or complex compounds thereof.

4) Silicone rubber formulations pursuant to one of the claims 1, 2, or 3, wherein
the filler material B) is selected from silicic acids having a surface area according to BET of between 50 and 400 m2/g,
the unsaturated hydrophobization agent F) is chosen from the group consisting of 1,3-divinyl tetramethyldisilazane and trialkoxysilanes with unsaturated alkenyl, alkenylaryl, acryl, methacryl groups,
the trimethylsilyl end-blocked polysiloxane G) is chosen from polysiloxanes with dimethylsiloxy, diphenylsiloxy or phenylmethylsiloxy groups, provided that it contains no functional groups that participate in the hydrosilylation reaction,
the polyhydrogen siloxane I) is a polyhydrogen siloxane that has at least two hydrogen atoms that are directly bonded to different silicone atoms, of the formula II
X₂DₘD^{H}ₙ
wherein
a) X=M, m:n>1,n≧1 and m+n>4,
b) X=MH, m≧1, n≧0 and m+n≧2, or
c) X=M and M^{H}, m≧1 and n>0
and the D units may be replaced, if necessary, by D^{Vi}, D^{Phe2}, D^{PheMe}T, T^{Phe}, Q, bis(dialkylsilyl)(C₁₋C₈)-alkanediyl, such as bis-dialkylsilylmethylene or bis-dialkylsilylethylene or bis-dialkylsilylarylene, the D^{H} units can be replaced by T^{H} if desired, and the M units can be replaced by M^{Vi}, M^{Phe}, with an SiH content of less than 10 mmol/g, preferably less than 9 mmol/g, and wherein the MeSiHO units are statistically separated by at least one of the units D, D^{Phe2}, D^{PheMe}, bis-dialkylsilylmethylene, bis-dialkylsilylethylene or bis-dialkylsilylarylene, and
the catalyst J), containing an element from the platinum group, is selected platinum and platinum compounds, that may be deposited on a carrier if desired, and other compounds of elements from the platinum group.

5) Silicone rubber formulations pursuant to one of the claims 1 through 4, characterized in that in the component I) statistically no SiH units are adjacent in the polymer chain, but are instead separated by other siloxy units, so that each MeSiHO-(D^{H}) unit is separated by at least one of the units D^{Vi}, D^{Phe2}, D^{PheMe}, T, T^{Phe}, Q, bis(dialkylsilyl)(C₁-C₈)-alkanediyl, such as Bis-dialkylsilylmethylene or bis-dialkylsilylethylene or bis-dialkylsilylarylene, and T^{H} is statistically separated from the next MeSiHO unit.

6) Silicone rubber formulations pursuant to one of the claims 1 through 5, characterized in that the molar ratio of the sum of the SiH groups in the component I) to the sum of the Si vinyl groups in the components A) and F) is 0.8 to 10.

7) Silicone rubber formulations pursuant to one of the claims 1 through 6, characterized in that as the catalyst J), 20-100 ppm Pt, based upon the total quantity of the components A) through I), in the form of Pt salts, Pt complex compounds with nitrogen, phosphorous and/or alkene compounds, or Pt metal on carriers may be used.

8) Silicone rubber formulations pursuant to one of the claims 1 through 7, characterized in that the saturated hydrophobization agent E) is selected from the group consisting of disilazanes, silylamines, and/or silanols.

9) Method for producing the silicone rubber formulations pursuant to one of the claims 1 through 8, characterized in that the components A) through I) are combined and mixed together.

10) Shaped articles, obtained by curing the silicone rubber formulations pursuant to one of the claims 1 through 9.

11) Use of the silicone rubber formulations or the shaped articles produced using said formulations, pursuant to one of the claims 1 through 10, to produce insulators.
